(19) United States
(12) Patent Application Publication
(10) Pub. No.: US 2020/0025219 A1
(43) Pub. Date: Jan. 23, 2020

(54) SERVO VALVE

(71) Applicant: Hamilton Sundstrand Corporation, Charlotte, NC (US)

(72) Inventor: Marcin KORCZYNSKI, Wroclaw (PL)

(21) Appl. No.: 16/435,882

(22) Filed: Jun. 10, 2019

(30) Foreign Application Priority Data
Jul. 20, 2018 (EP) 18461583.9

(51) Int. Cl. F15B 13/043; F16K 31/06

(52) U.S. Cl. CPC F15B 13/0438; F16K 31/0682

(57) ABSTRACT

A servo valve comprising a first fluid supply port, a fluid return port and a conduit therebetween, an elongated flapper having a portion arranged in the conduit, and an actuator configured to move the flapper in a direction orthogonal to a longitudinal axis of the flapper between a first blocking position in which it blocks the conduit such that fluid cannot flow from the first fluid supply port to the fluid return port and an first open position in which the conduit is open such that fluid can flow from the first fluid supply port to the fluid return port.

### FOREIGN PRIORITY

This application claims priority to European Patent Application No. 18461583.9 filed Jul. 20, 2018, the entire contents of which is incorporated herein by reference.

### FIELD

The present disclosure generally relates to a servo valve, and a method for controlling fluid flow in a servo valve.

### BACKGROUND

Servo valves are well-known in the art and can be used to control how much fluid is ported to an actuator. Servo valves include a housing that houses several components in cavities machined therein. Such components are well-known in the art, and include, for instance, fluid nozzles, spool valves, flappers, fluid ports etc. Flappers can move to selectively block and unblock fluid ports.

### SUMMARY

The present disclosure provides a servo valve comprising a first fluid supply port, a fluid return port and a conduit therebetween, an elongated flapper having a portion arranged in the conduit, and an actuator configured to move the flapper in a direction orthogonal to a longitudinal axis of the flapper between a first blocking position in which it blocks the conduit such that fluid cannot flow from the first fluid supply port to the fluid return port and an first open position in which the conduit is open such that fluid can flow from the first fluid supply port to the fluid return port.

The flapper may extend in a direction orthogonal to the conduit.

The flapper may extend through the conduit substantially orthogonal to the longitudinal axis of the conduit such that the longitudinal axis of the flapper is substantially orthogonal to the longitudinal axis of the conduit.

The servovalve may further comprise a first nozzle located in the conduit proximate the flapper such that in the first blocking position, the flapper blocks the conduit by blocking an opening in the nozzle, and in the first open position, the flapper does not block the opening in the nozzle.

The servovalve may further comprise a second fluid supply port in a wall of the conduit; and the actuator may be configured to move the flapper in a direction orthogonal to the longitudinal axis of the flapper between a second blocking position in which it blocks the conduit such that fluid cannot flow from the second fluid supply port to the fluid return port and a second open position in which fluid can flow from the second fluid supply port to the fluid return port.

In the second open position, fluid may be able to flow from both the first and second fluid supply ports to the fluid return port.

The servovalve may further comprise a second nozzle located in the conduit proximate the flapper such that in the second blocking position, the flapper blocks the conduit by blocking an opening in the second nozzle, and in the second open position, the flapper does not block the opening in the second nozzle.

The openings through the first and second nozzles may be coaxial.

The flapper may be arranged between the first and second nozzles.

The first and/or second open position may be located between the first blocking position and the second blocking position. The first and second open position may be the same position.

In the first blocking position, fluid may be able to flow from the second fluid supply port to the fluid return port. Alternatively, in the first blocking position, fluid may also be blocked from flowing from the second fluid supply port to the fluid return port.

In the second blocking position, fluid may be able to flow from the first fluid supply port to the fluid return port. Alternatively, or additionally, in the second blocking position, fluid may be blocked from flowing from the second fluid supply port to the fluid return port.

The flapper may have a fixed end and a free end opposed to the fixed end, and the actuator may be configured act on a portion of the flapper at or proximate the free end so as to move the flapper.

The flapper may configured to block the conduit at a location between the fixed end and the portion of the flapper acted on by the actuator. For example, the location may be approximately equidistant from the fixed end and the portion of the flapper acted on by the actuator. When the force is applied to the flapper, this may cause the flapper to bend or deform to move.

Alternatively, the flapper may comprise two opposing fixed ends, and the actuator may act to move the flapper between said fixed ends, such as midway therebetween.

The flapper may be bendable along its longitudinal axis.

The flapper may be configured to have an equilibrium position and is biased to said equilibrium position.

The flapper may not block the conduit in said equilibrium position.

For example, the flapper may not block the first and/or second nozzles in the equilibrium position.

Said equilibrium position may be the first and/or second open position.

The flapper may be resiliently bendable and when the force from the actuator is removed, the resiliency of the flapper may cause it to return to the equilibrium position, e.g. without any additional forces being provided thereto, such as from any additional elements, i.e. no additional elements such as biasing members may be required.

The actuator may comprise a first solenoid coil and a lever within the coil that is movable by magnetic fields generated by the coil when a current is applied thereto, and said lever may be coupled (e.g. attached or otherwise connected) to the flapper so as to move the flapper when the lever is moved.

The lever is made from a suitable material such that it is movable by the magnetic fields generated by the solenoid coil, such as a ferrous material. The lever may be a core of an electromagnet that comprises the solenoid.

An end of the flapper may be coupled to the lever.

Alternatively, the solenoid coil may generate magnetic fields that attract or repel the flapper directly, i.e. without the lever.

The actuator may further comprise a further solenoid coil, wherein the lever is arranged within the coil so as to be movable by magnetic fields generated by the further solenoid coil when a current is applied thereto so as to move the flapper when the lever is moved.

The second solenoid coil may act as a back-up in the event of failure of the first solenoid coil. The first and second solenoid coils may not act in combination.

Alternatively, the first and second solenoid coils may pull (or push) the lever in opposing directions so as to move the lever and hence flapper in opposing directions.

The current applied to the first and/or solenoid coil may be in a first direction so as to pull the lever, and may be reversed so as push the lever.

The present disclosure also provides a method for controlling fluid flow in a servo valve, comprising providing the servo valve as described herein, and moving the flapper in a direction orthogonal to the longitudinal axis of the flapper between the first blocking position and the first open position.

The method may further comprise providing a current to the first solenoid coil to move flapper.

The current may generate a magnetic field in the first solenoid coil, which may move the lever, or may move the flapper directly.

The method may further comprise providing a current to the, or a, second solenoid coil to move the flapper.

The current may generate a magnetic field in the second solenoid coil, which may move a lever, or may move the flapper directly.

### BRIEF DESCRIPTION OF DRAWINGS

Various embodiments will now be described, by way of example only, and with reference to the accompanying drawings in which:

FIG. 1 shows a cross-sectional view through a servo valve according to an embodiment of the invention;

FIG. 2 shows an exploded perspective view of the servo valve of FIG. 1; and

FIG. 3 shows a cross-sectional view of the servo valve of FIG. 1, showing the fluid ports.

### DETAILED DESCRIPTION

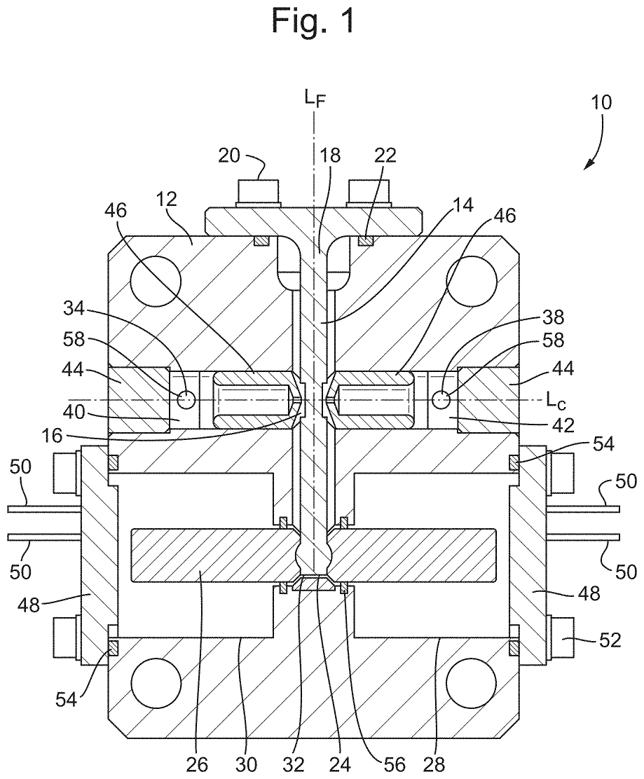

FIG. 1 shows a servo valve 10 comprising a housing 12. The servo valve 10 includes an elongated flapper 14 extending through a conduit 16 in the housing. The flapper has a longitudinal axis LF. The conduit may have a longitudinal axis LC. The longitudinal axis of the flapper LF may be substantially orthogonal to the longitudinal axis of the conduit LC. The flapper 14 may have a fixed end 18 fixed to the housing 12, e.g. by screws or bolts 20, and hermetically sealed to the housing 14 at the fixed end 18 by seal 22. The flapper 14 may also have a free end 24 opposing the fixed end 18. The free end 24 may be operatively connected to a core 26, that is located partially within a solenoid coil 28, by being located within an aperture or recess 32 in the core 26. The core 26 may extend substantially perpendicularly to the flapper 14. As will be described below, the core 26 acts as a lever for moving the flapper 14. The solenoid coil 28 and the core/lever 26 may be referred to as an actuator. The flapper 14 may move in a direction substantially orthogonal to the longitudinal axis of the flapper LF.

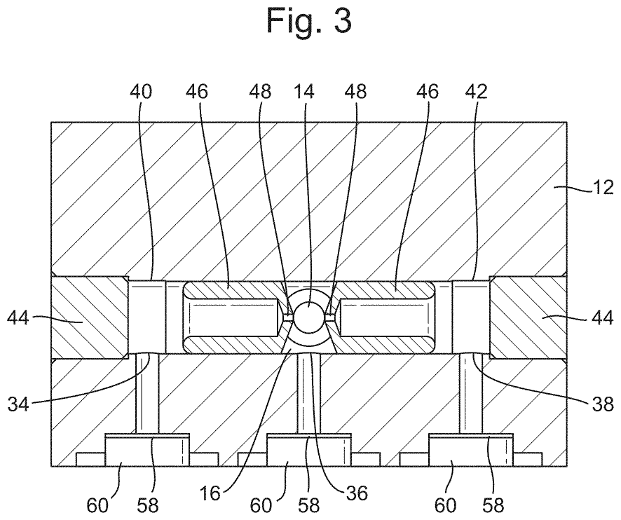

The servo valve 10 also includes at least one port, such as first, second and third ports 34, 36 (see FIG. 3), 38. The first and third ports 34, 38, may be located in fluid communication with the second port 36 and with each other via conduit portions 40,42. The conduit portions 40,42 may be plugged at the edge of the housing 12 by plugs such as lee plugs 44. The conduit portions 40, 42 may also include nozzles 46 having small or narrow openings arranged such that fluid must be communicated between the conduit portions 40, 42 via the openings of the nozzles 46. The second port 36 may be located in the conduit 16 between the nozzles. Blocking an opening in one of the nozzles therefore blocks fluid communication between the various ports 34,36,38.

When no current is applied to the solenoid coil 28, the flapper 14 may be in an initial or open position, wherein it does not block the conduit or nozzle openings. The core/lever 26 may be caused to move by applying a current to the solenoid coil 28. The lever 26 may thus apply a force to the flapper 14 in a direction substantially orthogonal to the longitudinal axis of the flapper 14. This causes the flapper 14 to move from its initial (open) position to a first blocking position to block a nozzle opening and thus the conduit portion from the first port 34 or second port 36 to the third port 38. The flapper 14 may bend in order to move to block the opening of a nozzle 46. For example, it may bend proximate to the fixed end. Alternatively, it may bend along its length. When the force is removed, the flapper 14 may return to the initial position. The flapper 14 may be formed from a resiliently bendable material, such that it returns to the initial (open) position without any external forces being applied. Each of the first, second and third ports may be fluid supply or return ports. For example, the first port 34 may a first fluid supply port, the second port 36 may be a second fluid supply port, and the third port 38 may be a fluid return port. It will be understood that any suitable arrangement of ports and conduit portions may be used, including any suitable number of supply and return ports.

The solenoid coil 28 may be secured in place with a cover 48, screws or bolts 52, and hermetic seal 54. The cover 48 may allow electrical connections 50 to pass therethrough to the coil 28.

Seals 56 may be provided in the channel in which the core/lever 26 is located, around the core/lever, e.g. so as to prevent fluid from the ports reaching the solenoids. In combination with the other seals, this provides a hermetically sealed servo valve.

The servo valve 10 may include an additional solenoid coil 30. The core/lever 26 may extend partially through and move within the additional solenoid coil 30. The additional solenoid 30 may be configured to be a back-up solenoid coil in the event of failure of the solenoid coil 28. It may be connected to a separate power supply (not shown).

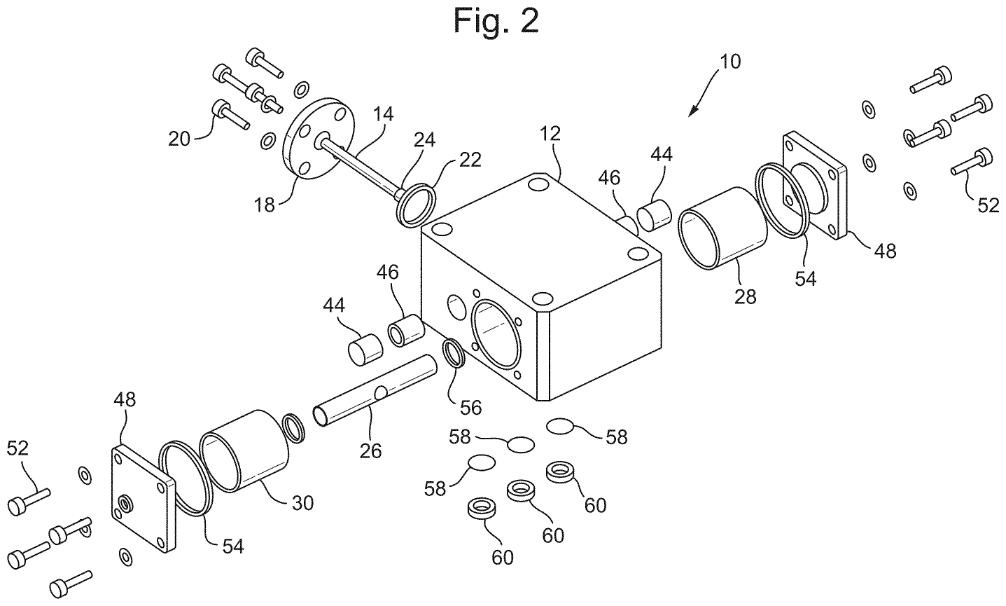

FIG. 2 shows an exploded view of the servo valve 10 of FIG. 1, so that the components may be seen more clearly. FIG. 2 shows filters 58, which may be located over the fluid supply and return ports 34, 36, 38. Screen rings 60 may secure the filters in a fixed position.

FIG. 3 shows a cross-sectional view in which the various fluid ports can be seen more easily. In the open position, the flapper 14 may be located between the openings 48 of the nozzles 46 such that both openings are open, and both conduit portions 40, 42 are open (not blocked). When the flapper is moved in the direction orthogonal to the longitudinal axis of the flapper 14 in one direction, it will be moved to a blocking position, wherein it blocks one of the openings 48 and thus blocks the related conduit portion 40,42. The opposing opening 48 and related conduit portion 40,42 will remain open. When the flapper is moved in the other direction, it will instead block the other of the openings 38 and the related conduit portion 40,42. For example, when the first port 34 is a first fluid supply port, the second port 36 is a second fluid supply port, and the third port 38 is a fluid return port, in the blocking position wherein the flapper 14 blocks the opening 48 related to conduit portion 40, fluid is blocked from flowing from first fluid supply port 34, and allowed to flow between second fluid supply port 36 and fluid return port 38. When the blocking position wherein the flapper 14 blocks the opening 48 related to conduit portion 42, fluid is blocked from flowing to the fluid return port from either the first fluid supply port 34 or the second fluid supply port 36.

The servo valve can be used in any aviation and industrial applications that require high flow of air, such as single stage servo valves, bleed valves, wing anti-ice valves, fuel metering units, and integrated fuel pump controls.

1. A servo valve comprising:
a first fluid supply port, a fluid return port and a conduit therebetween;
an elongated flapper having a portion arranged in the conduit; and
an actuator configured to move the flapper in a direction orthogonal to a longitudinal axis of the flapper between a first blocking position in which it blocks the conduit such that fluid cannot flow from the first fluid supply port to the fluid return port and an first open position in which the conduit is open such that fluid can flow from the first fluid supply port to the fluid return port.

2. The servo valve of claim 1, wherein the flapper extends through the conduit substantially orthogonal to a longitudinal axis of the conduit such that the longitudinal axis of the flapper is substantially orthogonal to the longitudinal axis of the conduit.

3. The servo valve of claim 1, comprising a first nozzle located in the conduit proximate the flapper such that in the first blocking position, the flapper blocks the conduit by blocking an opening in the first nozzle, and in the first open position, the flapper does not block the opening in the first nozzle.

4. The servo valve of claim 1, further comprising:
a second fluid supply port in a wall of the conduit; wherein the actuator is configured to move the flapper in a direction orthogonal to the longitudinal axis of the flapper between a second blocking position in which it blocks the conduit such that fluid cannot flow from the second fluid supply port to the fluid return port and a second open position in which fluid can flow from the second fluid supply port to the fluid return port.

5. The servo valve of claim 4, further comprising:
a second nozzle located in the conduit proximate the flapper such that in the second blocking position, the flapper blocks the conduit by blocking an opening in the second nozzle, and in the second open position, the flapper does not block the opening in the second nozzle.

6. The servo valve of claim 5, wherein the flapper is arranged between the first and second nozzles.

7. The servo valve of claim 1, wherein the flapper has a fixed end and a free end opposed to the fixed end, and wherein the actuator is configured to act on a portion of the flapper at or proximate the free end so as to move the flapper.

8. The servo valve of claim 7, wherein the flapper is configured to block the conduit at a location between the fixed end and the portion of the flapper acted on by the actuator.

9. The servo valve of claim 1, wherein the flapper is bendable along its longitudinal axis.

10. The servo valve of claim 1, wherein the flapper is biased to an equilibrium position.

11. The servo valve of claim 10, wherein the flapper does not block the conduit when in said equilibrium position.

12. The servo valve of claim 1, wherein the actuator comprises a first solenoid coil and a lever within the first solenoid coil that is movable by magnetic fields generated by the first solenoid coil when a current is applied thereto, and wherein said lever is coupled to the flapper so as to move the flapper when the lever is moved.

13. The servo valve of claim 1, wherein the actuator comprises:
a further solenoid coil, wherein the lever is arranged within the further solenoid coil so as to be movable by magnetic fields generated by the further solenoid coil when a current is applied thereto so as to move the flapper when the lever is moved.

14. A method for controlling fluid flow in a servo valve, comprising
providing the servo valve of claim 1; and
moving the flapper in a direction orthogonal to the longitudinal axis of the flapper between the first blocking position and the first open position.
